(19) United States
(12) Patent Application Publication
(10) Pub. No.: US 2016/0295149 A1
(43) Pub. Date: Oct. 6, 2016

(54) SIMULTANEOUS MULTI-CHANNEL TDI IMAGING ON A MULTI-TAP IMAGER

(71) Applicant: Thorlabs, Inc., Newton, NJ (US)

(72) Inventor: Ash PRABALA, Austin, TX (US)

(21) Appl. No.: 15/088,593

(22) Filed: Apr. 1, 2016

Related U.S. Application Data
(60) Provisional application No. 62/142,687, filed on Apr. 3, 2015.

(51) Int. Cl. H04N 5/372; H04N 5/378

(52) U.S. Cl. CPC H04N 5/37206; H04N 5/378

(57) ABSTRACT

A method for simultaneous time delay integration (TDI) imaging using multiple channels of a multi-tap device, including: translating a field of view (FOV) over a sample to be imaged; optically aligning a direction of travel of the FOV to a direction of charge transfer for each tap of the multi-tap device; and reading out the image data from each channel using settings that are appropriate to a particular application.

### CROSS-REFERENCE TO RELATED APPLICATIONS

This application claims the benefit of U.S. Provisional Patent Application No. 62/142,687 filed on Apr. 3, 2015. The disclosure of U.S. Provisional Patent Application 62/142,687 is hereby incorporated by reference.

### FIELD OF THE INVENTION

The invention generally relates to Time Delay Integration (TDI) imaging. More particularly, the invention relates to simultaneous Time Delay Integration (TDI) imaging using the multiple channels of a multi-tap device.

### BACKGROUND

While TDI is an effective mechanism for imaging an object (such as a microscope slide) while it is moving relative to the imager, there are significant tradeoffs when it comes to imaging more than one wavelength.

For example, some multi-wavelength solutions for TDI based scanning rely on multiple, often sequential scans, involving changing the light source, or switching filters between scans.

Disadvantages of using multiple scans include:
If the object has moved from one scan to the next, then the resulting images are of different moments in time.
For reasons of mechanical implementation, it is very difficult to align the different scans to the level of precision that is often needed in scientific imaging.
It takes longer to take multiple scans, resulting in slower overall throughput.

Some multi-wavelength solutions for TDI based scanning utilize on-imager Color Filter Arrays (CFAs: such as stripe, Bayer, Truesense panchromatic, mosaic and others which are commercially available).

Disadvantages of using CFAs include:
Reduced spatial resolution as compared to a scan that is taken with a monochrome sensor.
They are also not suitable in situations where there may be overlapping or co-located spectra.
Commercially available sensors use pigment or dye based CFAs with spectral characteristics that are not ideal for scientific applications such as (but not limited to) discriminating between co-located fluorophores.

Therefore, there is a need to provide a multi-wavelength solution that leverages TDI imaging and also takes advantage of the commercial availability of filters that are precisely matched to the needs of specific applications, and that does not have the above noted disadvantages.

### SUMMARY

This invention describes a method that permits, among other techniques, dual wavelength imaging using a dual-tap monochrome CCD (charged-coupled device). It would add dual-wavelength imaging to existing scanners, for example, the Whole Slide Scanners that are currently in late-stage development at Thorlabs.

One embodiment of the invention provides a method for simultaneous time delay integration (TDI) imaging using multiple channels of a multi-tap device, including: translating a field of view (FOV) over a sample to be imaged; optically aligning a direction of travel of the FOV to a direction of charge transfer for each tap of the multi-tap device; reading out the image data from each channel using settings that are appropriate to a particular application. Another embodiment further includes processing, reconstructing and displaying of the image data from each channel in a manner that is suitable for a particular application.

In one embodiment, some channels acquire TDI images corresponding to different spectral characteristics of a FOV. In one embodiment, some channels acquire spectrally dispersed TDI representations of a FOV. In one embodiment, some channels acquire hyperspectrally or multi spectrally dispersed TDI representations of a FOV. In one embodiment, some channels acquire TDI images of a FOV through one or more types of filters, for example, polarizers; 3D; analyzers; optical density; spatial filters; color filters and color filter arrays of various types. In one embodiment, some channels acquire TDI images of the FOV by using transmissive, reflective, fluorescent or spectroscopic materials or coatings, or phosphors either on their respective imaging areas or at a location in an optical path. In one embodiment, some channels acquire TDI images of different FOVs correspond to different locations, orientations, directions, depths, planes of focus, or regions-of-interest. In one embodiment, some channels acquire TDI images of FOVs and other channels acquire non-TDI images of the same or different FOVs. In one embodiment, some channels acquire TDI images of the FOV by means of specialized modalities that are known to practitioners of imaging, microscopy or spectroscopy.

The above methods can be combined in numerous ways; although not all combinations are diagrammed or discussed in detail.

The method may be implemented on various types of imagers, including, but not limited to, various implementations of CCDs and CMOS sensors.

For example, multiple TDI readouts could be on synchronous or different time bases. Some channels may be operating in non-TDI modes which may be on synchronous or different time bases.

Another example is to include Multi-channel support for “snapshot” TDI, as described in the publication WO2014059318A1, or continuous TDI (similar to that implemented in the Hamamatsu Orca R2 {with TDI option}), or a combination of TDI methods with the same or different gain and other camera parameters.

The horizontal shift registers of the imager can be used for split-row readout, and also for horizontal binning. Vertical binning may also be performed during readout.

Although most the discussions and diagrams in this document show dual-tap imagers, the technique is generalized to include imagers with more than two taps. Various implementations for the spatial separation are possible: various types of prisms, mirrors, fiber optic couplers, beam splitters, lenses, either individually or in combination. These components can be part of the FOV, or free-standing, or mounted to the imager (for example, fiber optic tapers and blocks that are bonded to imager channels for coupling).

Alignment and Orientation of the direction of travel of the FOV to the direction of charge transfer can be implemented using combinations of mirrors, splitters, prisms, lenses and other components that are familiar to optics designers

Various post processing and display options of the multiple channels are possible. Processing may be implemented in hardware, or in software running on an embedded machine or on a linked host-PC.

### BRIEF DESCRIPTION OF THE DRAWINGS

FIG. 1 illustrates a single and a dual tap CCD readout.

FIG. 2 illustrates a conventional TDI readout.

FIG. 3 illustrates a dual-tap TDI readout according to an embodiment.

FIG. 4 illustrates a general form with separate FOVs according to an embodiment.

FIG. 5 illustrates a general form with TDI imaging of the same FOV on a dual-tap imager according to another embodiment.

FIG. 6 shows a separation by wavelength implementation according to an embodiment.

FIG. 7 shows a TDI hyperspectral and TDI imaging according to an embodiment.

FIG. 8 shows a simultaneous generation of TDI and “normal” images according to an embodiment.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Terms such as “single-tap,” “dual-tap”, “top-half”, “bottom-half”, “halves”, “two FOVs” “two images” in the text and in the drawings refer to simplified cases for the purposes of convenience; the methods described are applicable to multi-tap devices with multiple FOVs resulting in multiple images. Also, while the operation of interline CCDs is described in some detail, the method may be implemented on various types of imagers, including, but not limited to, various implementations of CCDs and CMOS sensors. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

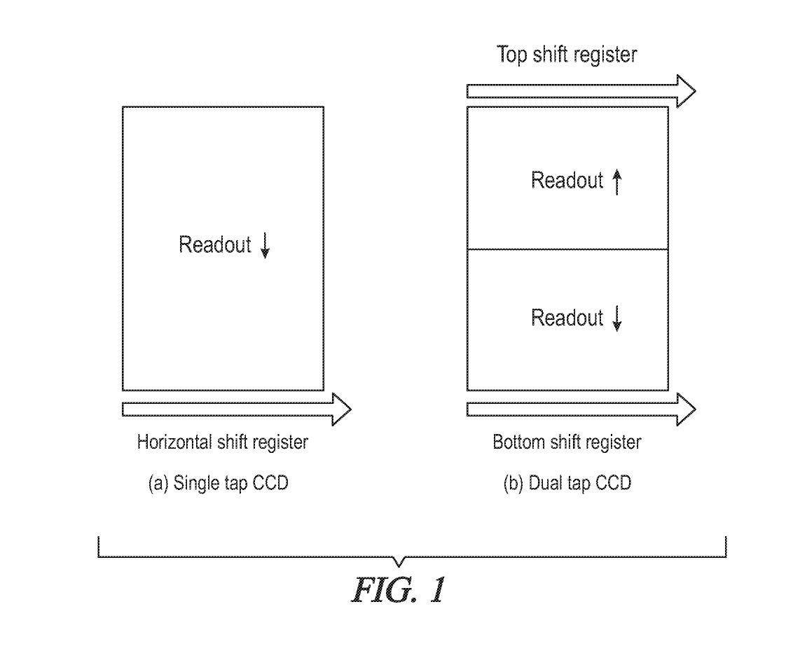

FIG. 1 (a) illustrates the operation of a conventional single-tap interline CCD. An interline CCD may be visualized as a device that develops a 2D matrix of electronic charges on a H×V pixel array. Each pixel accumulates a charge that is proportional to the number of incident photons during an exposure period. After the exposure period, each element of the charge matrix is shifted laterally into an adjacent element which is shielded from light. Stored charges are clocked vertically row-by-row, into a horizontal shift register. Once a line of charges is loaded onto the horizontal shift register, charges are serially clocked out of the device, and converted into voltages for the creation of an analog and/or digital display.

FIG. 1 (b) illustrates the conventional dual tap readout. In a dual tap interline CCD, there are two shift registers, shown schematically as the “Top” and “Bottom” shift registers.

In conventional dual-tap readout, the top and bottom halves of the charge matrix are clocked out in different directions—one towards the top shift register and the other towards the bottom shift register, from which they are clocked out of the device, converted into voltages and then digitized.

Note that imagers with more than two taps are also available, and the readout methods are similar to the one described above. Shift registers are often split, allowing for faster split-row readout of charges from the imager. Vertical and Horizontal binning may also be performed during readout.

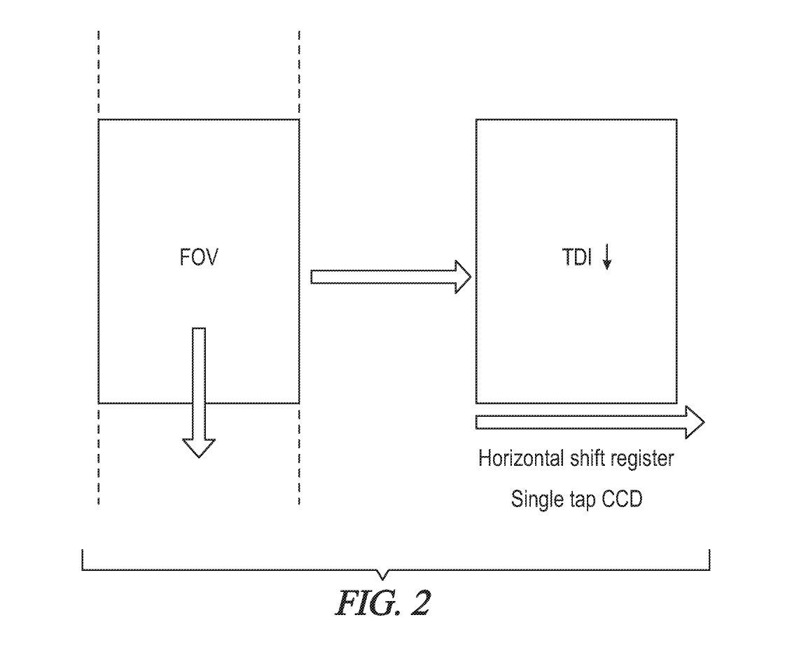

FIG. 2 illustrates the operation of the Conventional TDI readout. As the object being imaged translates through the field of view (FOV), its position is encoded in the form of timing pulses, which are used to generate horizontal-line-rate trigger pulses to the CCD. Precise calculation and control ensures that there is no relative motion between the object and the developing charge matrix. Rows of charges are developed in the photosensitive pixels, then summed with accumulated charges and transferred to integrate an image which is readout and reconstructed, either in hardware, but more typically in the host-PC.

International patent publication WO2014059318 A1 contains a more detailed description of CCD operation, in TDI and non-TDI operations. The entire contents of WO2014059318 A1 are hereby incorporated by reference.

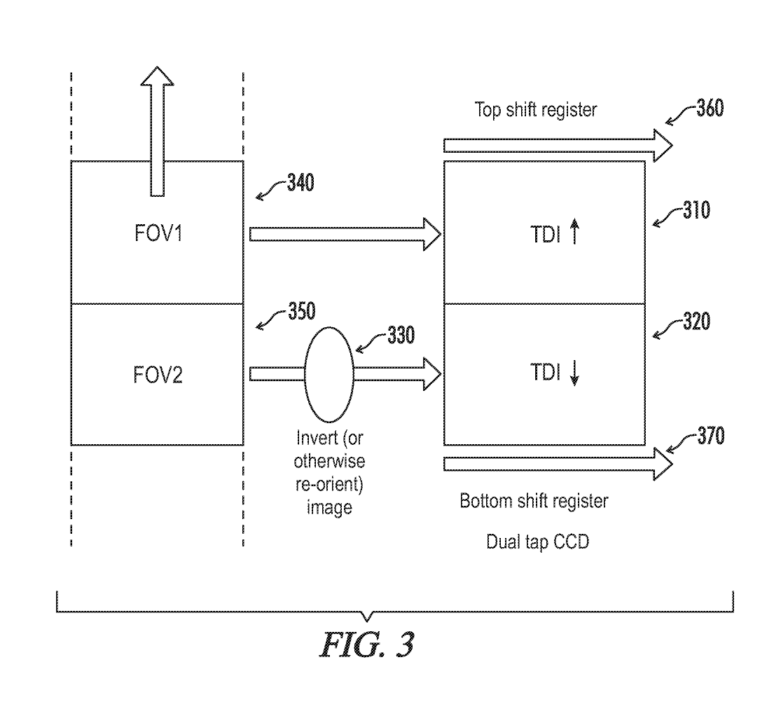

FIG. 3 illustrates a dual-tap TDI readout implementation in accordance with an embodiment. The proposed technique makes use of the fact that the top and bottom halves 310, 320 of the charge matrix move in opposite directions during dual-tap readout. A TDI clocking scheme is conceived with charges being shifted and summed in opposite directions, shown schematically as TDI ↑ and TDI ↓ in FIG. 3. A suitable means of optical inversion (or other necessary re-orientation) 330 is employed in order to align the motion in the FOV with the direction in which the charges are being clocked towards the shift register(s) 360, 370.

Note that two distinct FOVs 340, 350 are shown in FIG. 3 for the sake of clarity, and both halves 310, 320 of the imager are shown to be readout via a TDI clocking scheme.

In the implementations that follow, it is the application that dictates the choice of FOV as well as the suitable readout method. As mentioned previously, the technique can also be extended to multiple tap imagers, although dual-tap configurations are shown in this document for simplicity.

Implementations of the Principles

According to some embodiments of the invention, there are several implementations, which may be used independently or in combination to serve a multitude of applications.

It may be useful to divide the implementations into two broad categories:

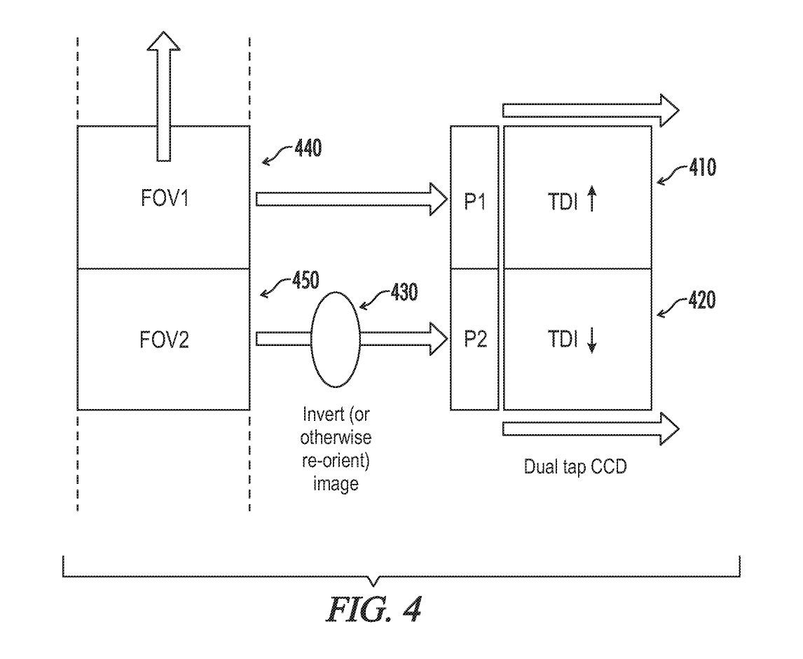

A) Different FOVs, 440, 450 imaged through same or different optical modalities on the multiple channels of a multi-tap imager. The generalized form of this category is shown in FIG. 4, in which P1 and P2 represent various possible components that may be placed in the optical paths.

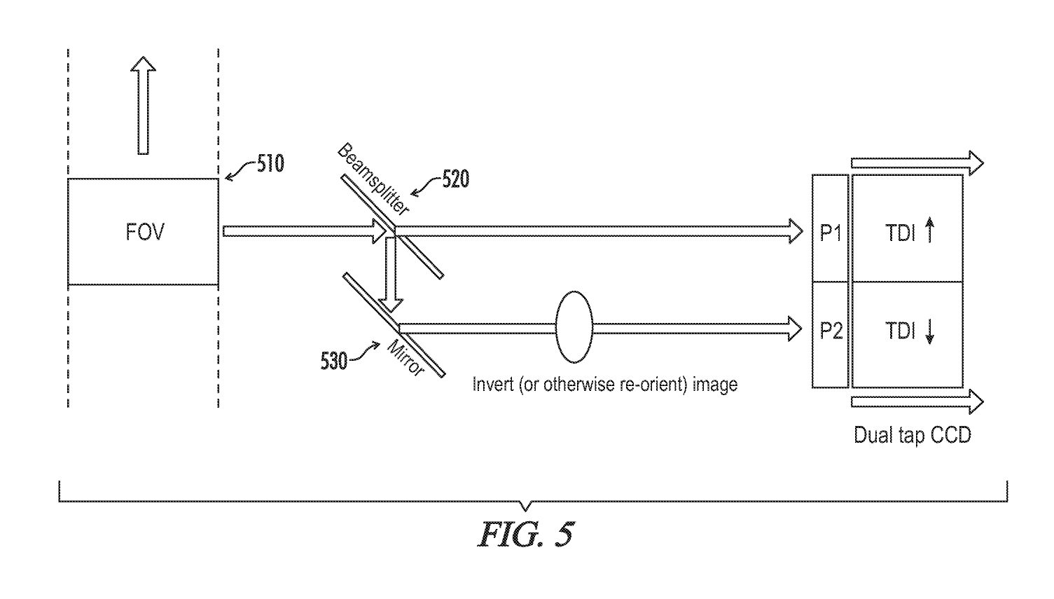

B) This is a special case of (A) in which FOV1=FOV2. The same FOV, is imaged through different optical modalities on the multiple channels of a multi-tap imager. A generalized form of this category is shown in FIG. 5. For example, in one embodiment, a beamsplitter 520 and a mirror 530 is used to spatially separate the light from the FOV 510. It is contemplated that other techniques may also be used to create spatially separated representations of a FOV.

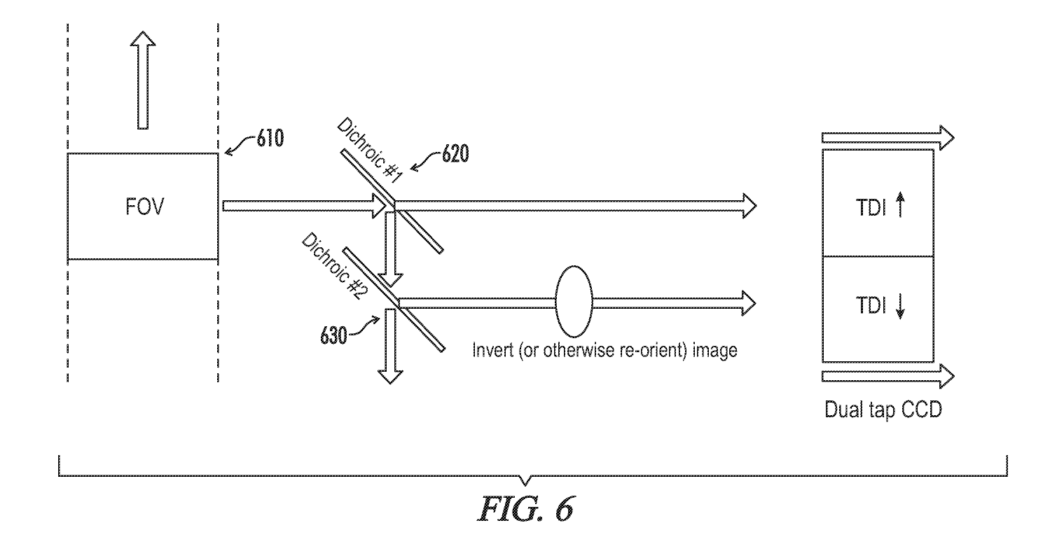

A selection of implementation examples is shown in FIGS. 6-8 in accordance with some embodiments of the invention.

In the implementation that is described in FIG. 6, the light from the FOV 610 is split spectrally AND spatially onto the two halves of a dual-tap imager, with one path inverted. For example, in one embodiment, two dichroic mirrors 620 and 630 are used to spectrally and spatially split the light from FOV 610. Note that since dichroic filters are available in low-pass, high-pass, single-edge and multi-edge variants, the colors are not intended to connote specific filters, or particular wavelengths being separated. Different combinations of VIS/NIR/SWIR (visible/near infrared/short wave infrared) and other wavelengths and spectral bands are also possible. It is contemplated that other techniques may also be used to generate spectrally and spatially separated images.

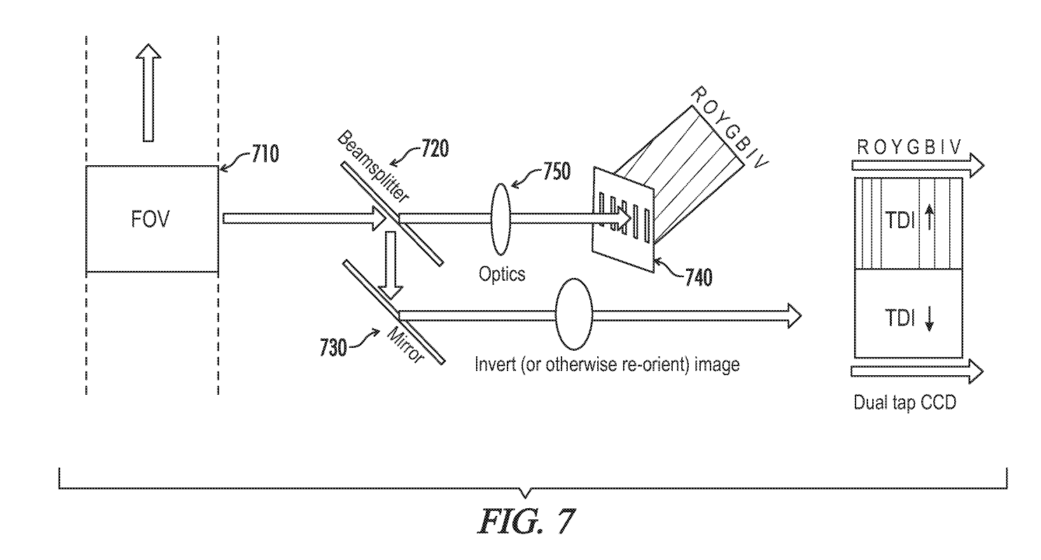

FIG. 7 shows a combination of TDI hyperspectral imaging (sometimes referred to as pushbroom hyperspectral imaging) and normal TDI imaging. In one embodiment, a beamsplitter 720 and a mirror 730 is used to spatially separate the light from the FOV 710. For example, in one embodiment, a grating 740 and optics 750 are used to generate a spectrum in one path. Note that the “normal” path could be implemented as having broadband or narrow-band spectral characteristics. In one embodiment, one or more channels of the imager could be operated in non-TDI readout mode as well. Note that the ROYGBIV (Red, Orange, Yellow, Green, Blue, Indigo, Violet) representation shown in FIG. 7 is not meant to limit the application to visible light. It is contemplated that other techniques may also be used to simultaneously project hyperspectral and normal representation of an FOV onto the imager.

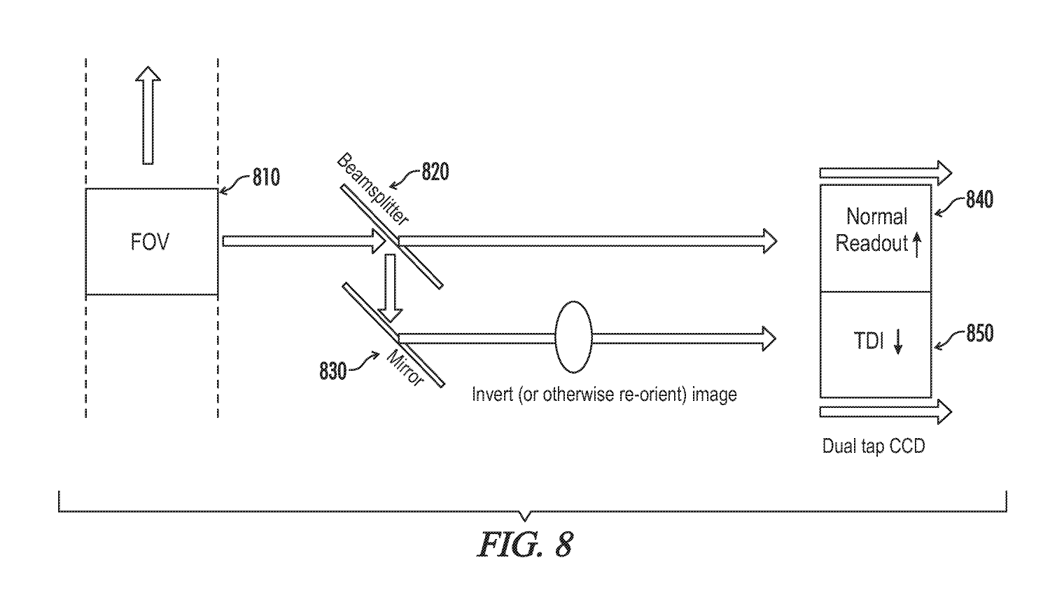

The implementation shown in FIG. 8 includes a “normal” readout from one tap 840, and a TDI readout from the other 850. In one embodiment, a beamsplitter 820 and a mirror 830 is used to spatially separate the light from the FOV 810. It is contemplated that other techniques may also be used to simultaneously created TDI and non-TDI images.

Application specific display and post-processing options of the image data from multiple channels are possible. Processing can be implemented in hardware, and/or in software running on an embedded machine or on a linked host-PC.

There are various display options according to some embodiments:
keep the channels separate,
overlay & annotate,
display the results of a math operation on the image data from multiple channels.

There are various Math operations according to some embodiments:
sums and differences of the image data from multiple channels, with and without gain & offset factors,
Ratios of the image data from multiple channels, with and without gain & offset factors,
Operations based on the different time bases of the multiple TDI readouts.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method for simultaneous time delay integration (TDI) imaging using multiple channels of a multi-tap device, comprising:
translating a field of view (FOV) over a sample to be imaged;
optically aligning a direction of travel of the FOV to a direction of charge transfer for each tap of the multi-tap device; and
reading out the image data from each channel using settings that are appropriate to a particular application.

2. The method of claim 1, further comprising processing, reconstructing and displaying of the image data from each channel in a manner that is suitable for a particular application.

3. The method of claim 1, wherein one or more channels acquire TDI images corresponding to different spectral characteristics of a FOV.

4. The method of claim 1, wherein one or more channels acquire spectrally dispersed TDI representations of a FOV.

5. The method of claim 4, the spectrally dispersed TDI representations are hyperspectrally or multi spectrally dispersed TDI representations of a FOV.

6. The method of claim 1, wherein one or more channels acquire TDI images of a FOV through one or more types of filters.

7. The method of claim 6, wherein the one or more types of filters are at least one of:
polarizers; 3D; analyzers; optical density; spatial filters; color filters and color filter arrays of various types.

8. The method of claim 1, wherein one or more channels acquire TDI images of the FOV by materials either on their respective imaging areas or at a location in an optical path.

9. The method of claim 8, wherein one or more channels acquire TDI images of the FOV using is at least one of: transmissive, reflective, fluorescent or spectroscopic materials or coatings, or phosphors.

10. The method of claim 1, wherein one or more channels acquire TDI images of different FOVs.

11. The method of claim 10, wherein the different FOVs correspond to different locations, orientations, directions, depths, planes of focus, or regions-of-interest on synchronous or asynchronous time bases with the same or different values for gain, offset, exposure and other image acquisition and readout settings.

12. The method of claim 1, wherein one or more channels acquire TDI images of FOVs and other channels acquire non-TDI images of the same or different FOVs.

13. The method of claim 1, wherein one or more channels acquire snapshot TDI images of FOVs and other channels acquire conventional TDI images of the same or different FOVs.

14. The method of claim 1, wherein one or more channels acquire TDI images with a particular value of gain and other settings, and others acquire images with different values of gain, offset, exposure and other image acquisition and readout settings.
